(19) United States
(12) Patent Application Publication
(10) Pub. No.: US 2024/0401956 A1
(43) Pub. Date: Dec. 5, 2024

(54) PATH GENERATION AND DISPLAY DEVICE AND PATH GENERATION AND DISPLAY METHOD

(71) Applicant: Panasonic Intellectual Property Management Co., Ltd., Osaka (JP)

(72) Inventors: Mei OKAMOTO, Kanagawa (JP); Naganori SHIRAKATA, Osaka (JP)

(21) Appl. No.: 18/690,174

(22) PCT Filed: Mar. 15, 2022
(86) PCT No.: PCT/JP2022/011649

§ 371 Date: Mar. 7, 2024

(30) Foreign Application Priority Data
Sep. 9, 2021 (JP) 2021-147098

(51) Int. Cl. G01C 21/20; G06F 40/40; G06Q 10/0631

(52) U.S. Cl. CPC G01C 21/206; G06F 40/40; G06Q 10/063114

(57) ABSTRACT

This path generation and display device is provided with: an extraction circuit that generates a first movement path taken by each of one or more workers from time-series data of position information indicating that the one or more workers performed work in a plurality of processes, and extracts behavioral characteristics associated with the times and processes for the movement path; a processing circuit that generates a second movement path to be recommended to the one or more workers, on the basis of the first movement path and the behavioral characteristics; and a monitor that displays the second movement path.

### TECHNICAL FIELD

The present disclosure relates to a route generation and display apparatus and a route generation and display method.

### BACKGROUND ART

To improve productivity in a production line of a cell production system or the like, there is a growing demand for a technology to keep track of and analyzing worker's activities that affect productivity.

For example, PTL 1 describes a technology for making it easy to find an abnormality in a production line of a production control manager by acquiring operation information on facilities and the positions of workpieces and workers and visualizing them with a running chart or the like.

### CITATION LIST

### Patent Literature

PTL 1
Japanese Patent Application Laid-Open No. 2012-022602

### SUMMARY OF INVENTION

Although it is possible to find unexpected abnormalities and their factors by displaying operation information (status) on facilities and the positions of workers, it is difficult to judge whether daily activities (working times, working sequences, and the like) of workers are appropriate. Therefore, even when displayed as described above, it is difficult to identify portions to be improved in a production line as a whole after finding an unexpected abnormality.

One non-limiting and exemplary embodiment facilitates providing a route generation and display apparatus and a route generation and display method each capable of generating and displaying a moving route recommended for a worker to judge whether worker's activity is appropriate.

A route generation and display apparatus of an exemplary embodiment for the present disclosure includes: an extraction circuit that generates a first moving route taken by each of one or a plurality of workers from time-series data of positional information indicating that the one or plurality of workers has worked in a plurality of processes and that extracts an activity characteristic associated with times and processes of the first moving route: a processing circuit that generates a second moving route recommended for the worker, in accordance with the first moving route and the activity characteristic; and a monitor that displays the second moving route.

A route generation and display method of an exemplary embodiment for the present disclosure includes: generating a first moving route taken by each of one or a plurality of workers from time-series data of positional information indicating that the one or plurality of workers has worked in a plurality of processes: extracting an activity characteristic associated with times and processes of the first moving route: generating a second moving route recommended for the worker, in accordance with the first moving route and the activity characteristic; and displaying the second moving route.

It should be noted that general or specific embodiments may be implemented as a system, a method, an integrated circuit, a computer program, a storage medium, or any selective combination thereof.

According to an embodiment of the present disclosure, it is possible to generate and display a moving route recommended for a worker to judge whether worker's activity is appropriate.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram showing an example of a production line on which worker's activity is estimated according to an embodiment of the present disclosure;

FIG. 2 is a configuration diagram showing an example of a worker's activity estimation system according to the embodiment of the present disclosure:

FIG. 3 is a diagram showing an example of a display screen layout of a display according to the embodiment of the present disclosure:

FIG. 4 is a diagram showing another example of a display screen layout of the display according to the embodiment of the present disclosure:

FIG. 5 is a diagram showing further another example of a display screen layout of the display according to the embodiment of the present disclosure;

FIG. 6 is a diagram showing an example of route display operation on one worker according to the embodiment of the present disclosure:

FIG. 7 is a diagram showing an example of analysis result display operation on one worker according to the embodiment of the present disclosure:

FIG. 8 is a diagram showing an example of prescribed route setting operation on one worker according to the embodiment of the present disclosure:

FIG. 9 is a diagram showing an example of process arrangement changing operation on one worker according to the embodiment of the present disclosure;

FIG. 10 is a diagram showing an example of route display operation on one group according to the embodiment of the present disclosure:

FIG. 11 is a diagram showing an example of analysis result display operation on one group according to the embodiment of the present disclosure:

FIG. 12 is a diagram showing an example of route display operation on a plurality of groups according to the embodiment of the present disclosure:

FIG. 13 is a diagram showing an example of analysis result display operation on a plurality of groups according to the embodiment of the present disclosure:

FIG. 14 is a diagram showing an example of a display screen layout of the display according to a modification of the embodiment of the present disclosure:

FIG. 15 is a diagram showing an example of route display operation on one worker according to a modification of the embodiment of the present disclosure:

FIG. 16 is a diagram showing an example of analysis result display operation on one worker according to a modification of the embodiment of the present disclosure:

FIG. 17 is a graph showing an example of time-series data of positional information of workers according to the embodiment of the present disclosure:

FIG. 18A is a view showing an example of activity characteristic data and recommended moving route data (second moving route data) according to the embodiment of the present disclosure; and

FIG. 18B is a view showing another example of activity characteristic data and recommended moving route data (second moving route data) according to the embodiment of the present disclosure.

### DESCRIPTION OF EMBODIMENTS

Hereinafter, an embodiment of the present disclosure will be described in detail with reference to the accompanying drawings as appropriate. Having said that, a detailed description more than necessary may be omitted, such as a detailed description of an already well-known matter and a duplicated description for a substantially identical configuration, to avoid the following description becoming unnecessarily redundant and to facilitate understanding by those skilled in the art.

Note that, the accompanying drawings and the following description are provided for those skilled in the art to sufficiently understand the present disclosure, and are not intended to limit the subject matter described in the claims.

### Embodiment 1

### <Production Line>

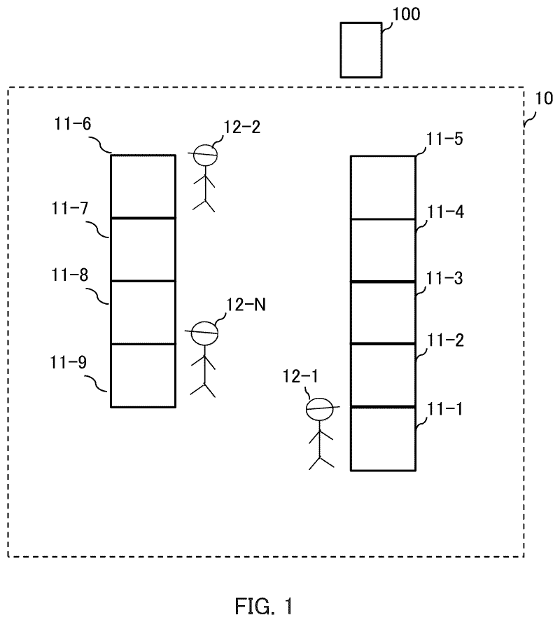

FIG. 1 is a diagram showing an example of a production line 10 on which worker's activity is estimated according to an embodiment of the present disclosure.

As shown in FIG. 1, production line 10 provided in, for example, a factory includes processes 11-1 to 11-5 arranged in a line and processes 11-6 to 11-9 arranged in another line.

In production line 10, workers 12-1 to 12-N each are in charge of one or more processes and, when one worker is in charge of a plurality of processes, the worker works while moving among the processes. Hereinafter, when workers 12-1 to 12-N do not need to be distinguished from one another, workers 12-1 to 12-N are collectively referred to as workers 12.

Worker's activity estimation system 100 that estimates activities of workers 12 is provided.

### <Worker's Activity Estimation System>

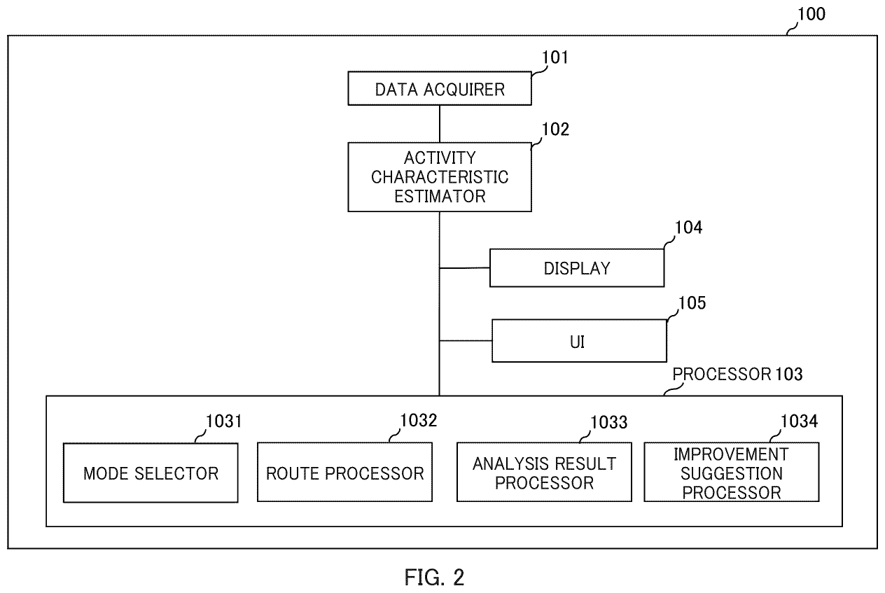

FIG. 2 is a configuration diagram showing an example of worker's activity estimation system 100 according to the embodiment of the present disclosure.

Worker's activity estimation system 100 acquires moving routes (which may be referred to as first moving routes) of workers 12-1 to 12-N in production line 10 and estimates activity characteristics from moving route data indicating the moving routes of workers 12. Worker's activity estimation system 100 extracts activity characteristic data that applies to conditions selected by a user (a production control manager, a system administrator, or the like) from the estimated activity characteristic data indicating the activity characteristics (which may be simply referred to as activity characteristics) of workers 12 and displays recommended moving route data (which may be referred to as second moving routes) in accordance with the extracted activity characteristic data.

Worker's activity estimation system 100 includes data acquirer 101, activity characteristic estimator 102, processor 103, display (monitor) 104, and UI (user interface) 105.

Data acquirer 101 acquires positional information of each of workers 12-1 to 12-N and stores the positional information in a data storer (not shown) provided in data acquirer 101 or a storage apparatus (not shown). Data acquirer 101 obtains the moving route (first moving route) of each of workers 12-1 to 12-N from time-series data of the positional information and outputs the moving route to activity characteristic estimator 102.

Time-series data of worker 12 may be acquired by recording the position of worker 12 time by time through, for example, image detection with a camera or a positioning technology performed by attaching a touch sensor, an infrared sensor, a wireless communication tag, or the like to processes and worker 12.

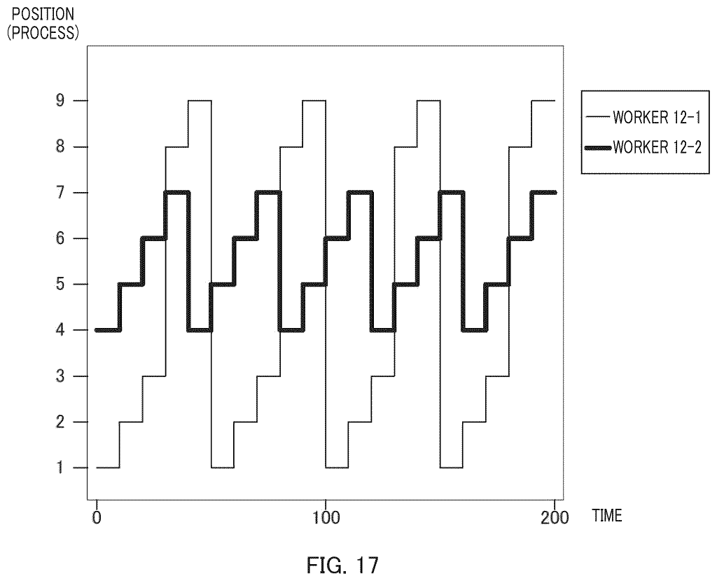

An example of time-series data of positional information of a worker according to the embodiment of the present disclosure will be described with reference to FIG. 17. The abscissa axis of the graph shown in FIG. 17 represents elapsed time (seconds) from reference time, and the ordinate axis of the graph represents processes (1 to 9 respectively represent process 11-1 to process 11-9). In this example, positional information of two worker 12-1 and worker 12-2 in a time section (for 200 seconds) is shown, and actually, positional information of workers 12 in various time sections is acquired by data acquirer 101.

Data acquirer 101 may be implemented by the above-described camera or various sensors or may be implemented by an interface apparatus that receives time-series data sent from the above-described camera or various sensors by wired or wireless communication.

Activity characteristic estimator 102 receives the moving route (first moving route) of worker 12, input from data acquirer 101. Activity characteristic estimator 102 extracts activity characteristic data indicating the activity characteristic of worker 12 in a mode from the received moving route of worker 12 and stores the activity characteristic data of worker 12 in a data storer (not shown) provided in activity characteristic estimator 102 or the storage apparatus (not shown). In this way, activity characteristic estimator 102 estimates the activity characteristic of worker 12 mode by mode in accordance with the moving route of worker 12. Activity characteristic data may exclude the activity characteristics of some of workers 12. For example, the activity characteristic of a worker who has cancelled to move between processes on the way may be deleted as an exceptional activity.

Activity characteristic estimator 102, for example, at the time of process design, causes the data storer to store a moving route planned and determined in advance as a reference for worker 12 to work (referred to as planned route) or a moving route set by the user as a prescribed route (which may be referred to as prescribed route). A moving route set by the user may be, for example, a moving route of which the frequency is the highest among a plurality of moving routes by worker 12, as will be described later. A prescribed route is a route that is a reference to be compared with a recommended moving route.

Activity characteristic estimator 102 receives user operation (input) on display 104 from processor 103 (for example, receiving a mode), extracts activity characteristic data according to the conditions of the mode, and outputs the activity characteristic data to processor 103.

Here, activity characteristic data may be the frequency (number of times) of moving route (first moving route) taken by worker 12 or may be a transition (moving) probability (including a probability that worker 12 remains in the same process) between processes in a process moving sequence taken by worker 12. More specifically, activity characteristic data indicates the frequency of moving route taken by worker 12 or a transition probability between processes by worker 12 and is associated with times and processes.

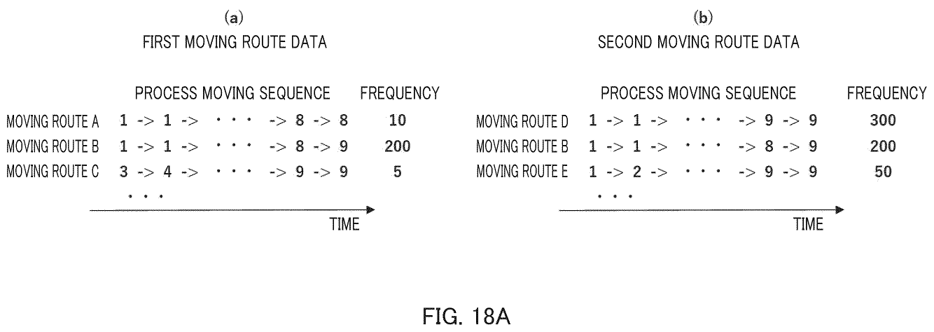

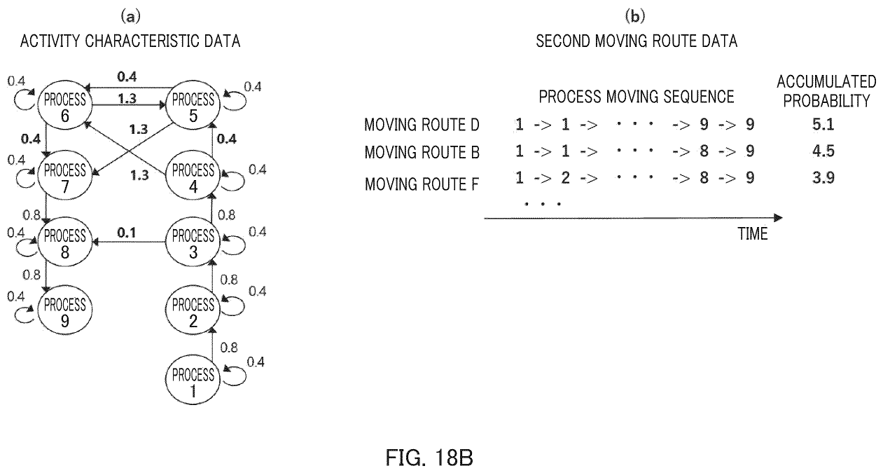

In an example, more specifically, as shown in (a) of FIG. 18A, activity characteristic data may be the frequency of each moving route (first moving route) extracted (calculated) from time-series data.

A moving route is a process moving sequence of worker 12, obtained by keeping track of a position (process) where worker 12 is working by a measurement interval (for example, every five seconds). A moving route is a combination of process transitions, and a retention time of one process does not need to be considered. When, for example, the process moving sequence is process 1, process 1, and process 2 by the measurement interval, a moving route is regarded as process 1 and process 2.

The process moving sequence of (a) of FIG. 18A shows that, for example, moving route A remains in process 1 in the first measurement interval and remains in process 1 in the subsequent measurement interval, and similarly moving route C remains in process 3 in the first measurement interval and remains in process 4 in the subsequent measurement interval.

Activity characteristic estimator 102 calculates a frequency that is activity characteristic data on the assumption that the same process moving sequence is the same moving route. (a) of FIG. 18A shows that worker 12 takes moving route A 10 times in a predetermined period, worker 12 takes moving route B 200 times in the predetermined period, and worker 12 takes moving route C five times in the predetermined period. The same applies to the other moving routes.

In another example, more specifically, as shown in (a) of FIG. 18B, activity characteristic data may be a probability (transition probability) that worker 12 has moved from a process to another process or has remained in a process in a process moving sequence of a moving route (first moving route) extracted (calculated) from time-series data. A transition probability P(i,j) from process i to process j is expressed by the expression P(i,j)=N(i,j)/Nₐₗₗ. Here, N(i,j) is the number of times of transition from process i to process j in a display period or a date and time range that will be described later, and Nₐₗₗ is the total number of times of transition in a display period or a date and time range. Nₐₗₗ may be the sum of the number of times of transition from process i to any one of process 1 to process 9 or a prescribed number of times of transition may be determined. In the present embodiment, i and j each are an integer larger than or equal to one and smaller than or equal to nine.

For example, (a) of FIG. 18B shows that the probability that worker 12 has remained in process 1 and has remained in process 1 after the measurement interval (for example, five seconds later) is 0.4, and the probability that worker 12 has remained in process 1 and has remained in process 2 after the measurement interval is 0.8. Similarly, (a) of FIG. 18B shows that the probability that worker 12 has remained in process 4 and has remained in process 4 after the measurement interval is 0.4, the probability that worker 12 has remained in process 4 and has remained in process 5 after the measurement interval is 0.4, and the probability that worker 12 has remained in process 4 and has remained in process 6 after the measurement interval is 1.3. The same applies to the other processes. The above-described probabilities are not normalized.

Activity characteristic data may be a difference from a working time in a planned route. Activity characteristic data may be, for example, a difference from a total working time of a planned route, a degree of reduction from a total working time of a planned route, a difference from a working time of each process included in a planned route, or a degree of reduction from a working time of each process included in a planned route, or may be a combination of them. Activity characteristic data may be any combination of a frequency, a transition probability, and a difference from a working time in a planned route.

Activity characteristic estimator 102 may be implemented by, for example, a processing apparatus, such as a processor.

Processor 103 includes mode selector 1031, route processor 1032, analysis result processor 1033, and improvement suggestion processor 1034. Processor 103 may be implemented by, for example, a processing apparatus, such as a processor.

Mode selector 1031 receives user operation on display 104 and signals or data from route processor 1032, analysis result processor 1033, and improvement suggestion processor 1034 as input.

Mode selector 1031 selects a mode according to user operation (user selection) to a display target, a display period, and a measurement interval, displayed on display 104, and outputs the selected mode to activity characteristic estimator 102.

More specifically, mode selector 1031 selects a worker or the like (display target) selected and set by the user and of which moving route data is to be displayed, a date and time range (for example, a start date and time and a stop date and time, a start date and time and a display time, or the like, as a display period) selected and set by the user and of which moving route data is to be displayed, and a time interval (measurement interval) selected and set by the user and used to perform conversion between activity characteristic data and time-series data acquired by data acquirer 101, as a mode selected and set by the user (conditions of the mode). As for a time interval selected and set by the user, the user may select a value greater than a sampling interval of time-series data acquired by data acquirer 101 or the user may select from among prescribed choices.

After the user selects a mode, mode selector 1031 calculates an average working time, maximum working time, or the like (working time) of the production line (all the processes) in the selected mode. Mode selector 1031 instructs display 104 to display the display target, display period, and measurement interval selected and set by the user and the working time calculated by mode selector 1031.

Route processor 1032 receives user operation on the display 104, signals or data from mode selector 1031, analysis result processor 1033, and improvement suggestion processor 1034, and activity characteristic data from activity characteristic estimator 102 as input.

Route processor 1032 receives activity characteristic data of the mode selected by mode selector 1031 from activity characteristic estimator 102, generates recommended moving route data (second moving route) by converting the first moving route in accordance with the activity characteristic data, and outputs the generated recommended moving route data to analysis result processor 1033.

In an example, a case where activity characteristic data is the frequency (occurrence frequency) of moving route taken by worker 12 will be discussed. Route processor 1032 generates recommended moving route data (second moving routes) by converting first moving route data shown in (a) of FIG. 18A, input from activity characteristic estimator 102, specifically, sorting the moving routes in descending order of frequency. For example, as shown in (b) of FIG. 18A, route processor 1032 generates recommended moving route data such that moving routes are arranged in order of moving route D taken by worker 12 300 times, moving route B taken by worker 12 200 times, moving route E taken by worker 12 50 times, . . . .

In another example, a case where activity characteristic data is a transition probability between processes of worker 12 will be discussed. In this case, route processor 1032 generates recommended moving route data (second moving route data) by converting activity characteristic data shown in (a) of FIG. 18B and input from activity characteristic estimator 102, specifically, calculating an accumulated transition probability (hereinafter, referred to as accumulated probability) obtained by adding up the transition probabilities of processes for each first moving route and then sorting the first moving routes in descending order of accumulated probability.

Accumulated probability X is the sum of transition probabilities from time tₖ to time t_{T} in the process moving sequence in each moving route and is expressed by the expression X=Pt₁(i,j)+Pt₂(i,j)+ . . . +Pt_{T}(i,j). Here, Ptₖ(i,j) is a transition probability from process i to process j at time tₖ (k is an integer larger than or equal to one and smaller than or equal to T). In the present embodiment, i and j each are an integer larger than or equal to one and smaller than or equal to nine. For example, as shown in (b) of FIG. 18B, route processor 1032 generates new moving route data such that moving routes are arranged in order of moving route D of which the accumulated probability is 5.1, moving route B of which the accumulated probability is 4.5, moving route F of which the accumulated probability is 3.9 . . . . In this case, route processor 1032 treats accumulated probability as frequency.

As described above, activity characteristic estimator 102 may, for example, calculate the number of times of occurrence (frequency) of the first moving route in a predetermined period by worker 12 in the selected mode and generate recommended moving route data (second moving route data) in accordance with the calculated frequency or the like.

As described above, activity characteristic estimator 102 may calculate a transition probability between processes of the first moving route of worker 12 in the selected mode, calculate an accumulated probability for each first moving route, and generate recommended moving route data (second moving route data) in accordance with the calculated transition probabilities and accumulated probabilities, or the like.

Route processor 1032 receives analysis result data of the activity characteristic, such as the frequency, of moving route taken by worker 12 from analysis result processor 1033.

Route processor 1032 instructs display 104 to display a process arrangement map and pieces of moving route data having higher frequencies. Route processor 1032, for example, causes display 104 to display top three pieces of moving route data (second moving route data) in descending order of frequency on the process arrangement map that is a two-dimensional coordinate system.

Route processor 1032 causes display 104 via route processor 1032 or another processor to perform display according to user operation on display 104.

Analysis result processor 1033 receives user operation on the display 104, signals or data from mode selector 1031, route processor 1032, and improvement suggestion processor 1034, and activity characteristic data from activity characteristic estimator 102 as input.

Analysis result processor 1033 receives activity characteristic data in the mode selected by mode selector 1031 from activity characteristic estimator 102 and receives recommended moving route data (second moving route data) from route processor 1032.

Analysis result processor 1033 calculates the frequency of moving route for each recommended moving route as an analysis result in accordance with the activity characteristic data input from activity characteristic estimator 102 and the recommended moving route data input from route processor 1032.

Analysis result processor 1033 outputs analysis result data including the frequency of each moving route to route processor 1032 and improvement suggestion processor 1034.

Analysis result processor 1033 instructs display 104 to display pieces of moving route data having higher frequencies (for example, top three pieces of moving route data in descending order of frequency).

Analysis result processor 1033 causes display 104 via analysis result processor 1033 or another processor to perform display according to user operation on display 104.

Generation of recommended moving route data and calculation of frequency may be performed by activity characteristic estimator 102 as described above.

Improvement suggestion processor 1034 receives user operation on display 104, signals or data from mode selector 1031, route processor 1032, and analysis result processor 1033, and activity characteristic data from activity characteristic estimator 102 as input.

Improvement suggestion processor 1034 receives recommended moving route data from route processor 1032 and receives analysis result data from analysis result processor 1033.

Improvement suggestion processor 1034 detects a difference in the retention time and moving sequence of processes between moving routes with higher frequencies and the prescribed route in accordance with the recommended moving route data and the analysis result data as detection information and converts the fact that there is room for improvement in process, moving path, or the like corresponding to the prescribed route into a natural language.

Improvement suggestion processor 1034 may instruct display 104 to display the features of the activity characteristic and improvement suggestion data converted into a natural language.

Improvement suggestion processor 1034 causes display 104 via improvement suggestion processor 1034 or another processor to perform display according to user operation on display 104.

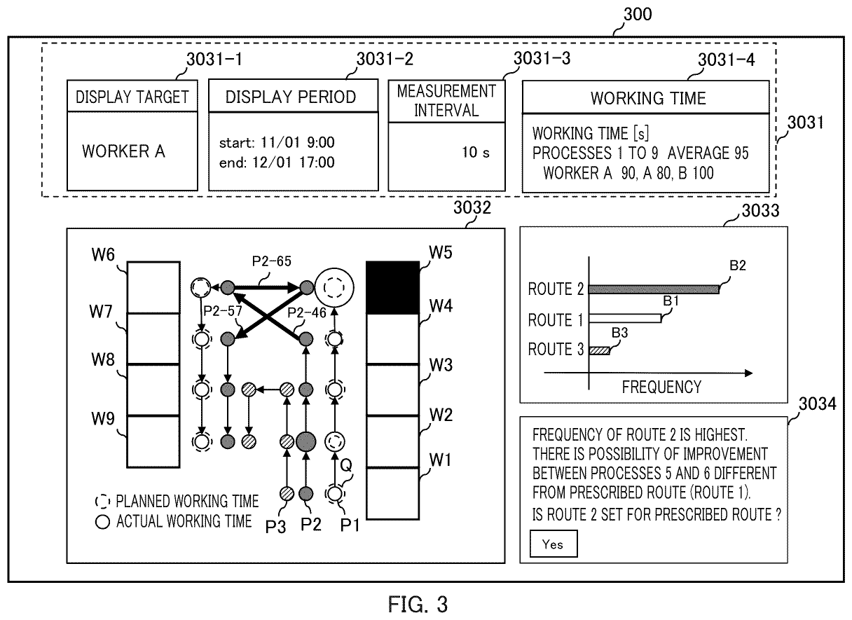

Display 104 displays data input from mode selector 1031, route processor 1032, analysis result processor 1033, and improvement suggestion processor 1034 as a display screen 300 (see FIG. 3 or the like). Display 104 may be implemented by, for example, an LCD, a touch panel, or the like.

UI 105 receives user operation to processor 103 from display screen 300, converts the user operation to a signal indicating the user operation, and outputs the signal to processor 103. UI 105 may be included in display 104.

These data acquirer 101, activity characteristic estimator 102, processor 103, display 104, and UI 105 are connected by a bus cable. Processing of activity characteristic estimator 102, processor 103, and the like implemented by a processor may be executed by, for example, the processor running a program stored in a storage apparatus, such as a memory.

Worker's activity estimation system 100, activity characteristic estimator 102, processor 103, and display 104 are respectively examples of the route generation and display apparatus, the extractor, the processor, and the display according to the present disclosure.

### (Examples of Display Screen Layout)

### [Example of Display Screen Layout for One Worker]

FIG. 3 is a diagram showing an example of a display screen layout of display 104 according to the embodiment of the present disclosure. In this example, a display screen layout for one worker is shown.

Display 104 contains mode display section 3031 in which data and the like input from mode selector 1031 are displayed, route display section 3032 in which data and the like input from route processor 1032 are displayed, analysis result display section 3033 in which data and the like input from analysis result processor 1033 are displayed, and improvement suggestion display section 3034 in which data and the like input from improvement suggestion processor 1034 are displayed, in display screen 300.

Mode display section 3031 contains display target display section 3031-1, display period display section 3031-2, measurement interval display section 3031-3, and working time display section 3031-4.

Display target display section 3031-1 displays one target worker selected and set by the user (selected by mode selector 1031). Display target display section 3031-1 may display workers so that the user is able to select a worker for which recommended moving route data is displayed. Alternatively, a display screen region different from display target display section 3031-1 may display workers so that the user is able to select a worker for which recommended moving route data is displayed. A display (selection) target may include a worker's name of one or more workers, worker identification information (ID) associated with a worker, a group name of a worker group (also simply referred to as group) including a plurality of workers, a group ID associated with a group, and the like. Display target display section 3031-1 may register in advance a list of workers or groups that the user can select, and display the list when the user performs predetermined operation.

Display period display section 3031-2 displays a date and time range selected and set by the user. Display period display section 3031-2 may display a date and time range so that the user can select a date and time range in which recommended moving route data is displayed. Alternatively, a display screen region different from display period display section 3031-2 may display a date and time range so that the user can select the date and time range in which recommended moving route data is displayed.

Measurement interval display section 3031-3 displays a time interval selected and set by the user. Measurement interval display section 3031-3 may display time intervals so that the user can select a time interval. Alternatively, a display screen region different from measurement interval display section 3031-3 may display time intervals so that the user can select a time interval.

Working time display section 3031-4 displays a working time calculated by mode selector 1031.

In this way, mode display section 3031 displays a combination of conditions that recommended moving route data is displayed (referred to as a mode or conditions of mode) to be selected and set by the user.

Route display section 3032 displays recommended moving route data having higher frequencies (for example, top three pieces of moving route data in descending order of frequency) on the process arrangement map for one target worker displayed (selected) in display target display section 3031-1. Route display section 3032 may display a moving route taken by the target worker, in addition to the recommended moving route data. Thus, it is easy to make a comparison with recommended moving routes.

Route display section 3032 displays processes W1 to W9 respectively representing “processes 1 to 9”, routes P1 to P3 representing “routes 1 to 3” along which the worker has moved, planned route Q planned in advance, and P2-46, P2-65, and P2-57 that are moving paths between processes of route P2. In FIG. 3, planned route Q is the same route as route P1.

Processes W1 to W9 are such that process arrangement in production line 10 is represented on the process arrangement map. Routes P1 to P3 are such that moving route data is represented on the process arrangement map by circles and arrows. Routes P1 to P3 include a retention time of each process and a moving sequence of processes for the worker. The length of retention time is represented by the size of a circle, and the moving sequence is represented by the orientation of an arrow. Planned route Q is a route that includes a working time planned in advance (also referred to as planned working time) and a working sequence planned in advance (also referred to as planned working sequence).

Route display section 3032 highlights a different portion between planned route Q and each of routes P1 to P3 by changing at least one of the width, light and shade, color, and the like, of a line. For example, a difference between a retention time and a planned working time in process W5 significantly varies from a predetermined value between route P1 and planned route Q, so route display section 3032 may highlight process W5 with a black shade. A process of which a difference between a retention time and a planned working time is the largest among processes may be highlighted. Since a moving sequence between processes is varied between route P1 and route P2, route display section 3032 may highlight moving path P2-46 from process W4 to process W6, moving path P2-65 from process W6 to process W5, and moving path P2-57 from process W5 to process W7 with a wide-line arrow.

Route P and planned route Q may be configured to be distinguished from each other at a glance by, for example, setting the style of the line of route P to continuous line, setting the style of the line of planned route Q to dashed line.

Thus, the user is able to compare a difference in retention time and a difference in moving sequence for each route at a glance. It is also possible to compare an actual retention time and a moving sequence with a planned working time and a planned working sequence, so the user is able to easily check a difference between an actual activity of the worker and a plan.

Analysis result display section 3033 displays pieces of moving route data having higher frequencies (top three pieces of moving route data in descending order of frequency) on the graph for the target worker selected in display target display section 3031-1.

In analysis result display section 3033, the ordinate axis of the graph represents route number, and the abscissa axis of the graph represents frequency. B1 to B3 are bars respectively represent the frequencies of routes P1 to P3 of route display section 3032 and are displayed in descending order of frequency. For example, in analysis result display section 3033, the frequency bars are arranged in order of B2, B1, and B3 from top, so it is found that the worker is moving more frequently in order of the corresponding routes P2, P1, and P3. The number of frequency bars B displayed may be greater than the number of routes P of route display section 3032.

Thus, the user is able to easily determine a route along which the worker has frequently moved, a route along which the worker has unexpectedly moved, or the like.

Improvement suggestion display section 3034 displays improvement suggestion data that detection information detected by route display section 3032 and analysis result display section 3033 is converted into a natural language, for one target worker selected in display target display section 3031-1. Such detection information includes, for example, the process number of a process in which a retention time is longer by a prescribed value or longer than a planned working time, the route number of a route with a moving path different from that of a planned working sequence, the route number of a route with a higher frequency than a planned route, and the like. Improvement suggestion display section 3034 displays a button (“Yes” button in FIG. 3) for selecting whether the user accepts a displayed improvement suggestion.

Thus, the user is able to easily find a difference between planned route Q and each of routes P1 to P3 displayed in route display section 3032 and analysis result display section 3033 and features.

An example of data that is a source of data to be displayed on display 104 is shown in the following Table 1.

TABLE 1
Data That Is Source of Display Data When Worker A Is Selected

| | Route | Retention Process | Fre- | Measurement |
|---|---|---|---|---|
| TARGET | Number | Sequence | quency | Interval [s] |
| WORKER A | 2 | 1, 2, 3, 4, 6, 5, 7. 8, 9 | 300 | 5 |
| | 1 | 1, 2, 3, 4, 5, 6, 7, 8, 9 | 200 | |
| | 3 | 1, 2, 3, 8, 9 | 50 | |
| . . . | . . . | . . . | . . . | . . . |

Data that is a source of data to be displayed on display 104, as shown in Table 1, may be shared among route processor 1032, analysis result processor 1033, and improvement suggestion processor 1034, or may be individually held by each of route processor 1032, analysis result processor 1033, and improvement suggestion processor 1034. Such data includes further data, such as a process retention time.

Table 1 shows that, in a period, the frequency that worker A has taken route P2 that is a moving sequence “1→2→3→4→6→5→7→8→9” is 300, the frequency that worker A has taken route P1 that is a moving sequence “1→2→3→4→5→6→7→8→9” is 200, and the frequency that worker A has taken route P3 that is a moving sequence “1→2→3→8→9” is 50.

### [Example of Display Screen Layout for One Group]

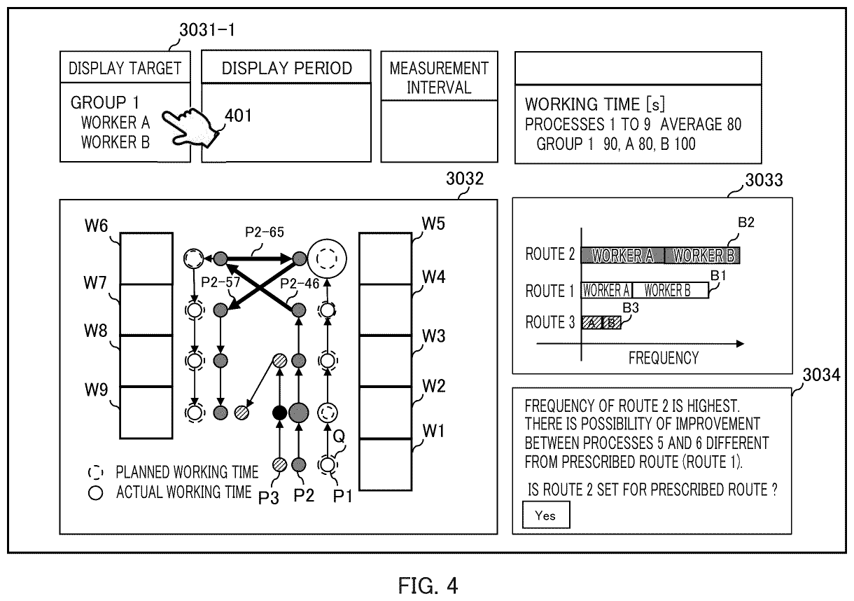

FIG. 4 is a diagram showing another example of a display screen layout of display 104 according to the embodiment of the present disclosure. In this example, a display screen layout for one group including a plurality of workers is shown.

Basically, the display screen layout for one worker, shown in FIG. 3, and the display screen layout for one group, shown in FIG. 4, are similar to each other and differ from each other in that, in the display screen layout for one group, shown in FIG. 4, the subject of data displayed in route display section 3032, analysis result display section 3033, and improvement suggestion display section 3034 is one group (a plurality of workers) selected in display target display section 3031-1. Here, as shown in FIG. 4, group 1 includes worker A and worker B. A group may include three or more workers.

The user operates to select group 1 from display target display section 3031-1 with pointer 401. Then, a signal according to the operation is output to mode selector 1031 via UI 105. Mode selector 1031 makes a request of activity characteristic estimator 102 for activity characteristic data on both worker A and worker B in response to the operation. Activity characteristic estimator 102 outputs activity characteristic data on both worker A and worker B to processor 103 in response to the request. Route processor 1032, analysis result processor 1033, and improvement suggestion processor 1034 execute respective processes, that is, generating recommended moving route data and other processes, in accordance with the activity characteristic data output from activity characteristic estimator 102, and route display section 3032, analysis result display section 3033, and improvement suggestion display section 3034 display data in respective formats.

When the user selects group 1 in display target display section 3031-1, route display section 3032 switches routes P1 to P3 displayed as shown in, for example, FIG. 3, and displays, for example, top three routes having higher frequencies of routes along which the workers included in group 1 have moved.

Analysis result display section 3033 switches frequency bars B displayed and displays the frequencies of routes P along which the workers included in group 1 have moved. At this time, frequency bars B1 to B3 may be displayed as stacked bar charts that show worker A and worker B as distinguished from each other.

Furthermore, improvement suggestion display section 3034 switches the displayed natural language indicating the features of activity and displays detection information on group 1 detected in accordance with routes P and planned route Q of route display section 3032, frequency bars B of analysis result display section 3033, and the like.

Thus, the user is able to check the activity characteristics of the overall group including a plurality of workers as process retention times, process moving sequences, the frequencies of the routes, and the like and intuitively find notable routes and a difference between routes and the like.

An example of data that is a source of data to be displayed on display 104 is shown in the following Table 2.

TABLE 2
Data That Is Source of Display Data When Group 1 Is Selected

| | Route | Retention Process | | Measurement |
|---|---|---|---|---|
| TARGET | Number | Sequence | Frequency | Interval [s] |
| GROUP 1 | 2 | 1, 2, 3, 4, 6, 5, 7. 8, 9 | 550 | 10 |
| | 1 | 1, 2, 3, 4, 5, 6, 7, 8, 9 | 400 | |
| | 3 | 1, 2, 3, 9 | 110 | |
| . . . | . . . | . . . | . . . | . . . |

Data that is a source of data to be displayed on display 104, as shown in Table 2, may be shared among route processor 1032, analysis result processor 1033, and improvement suggestion processor 1034, or may be individually held by each of route processor 1032, analysis result processor 1033, and improvement suggestion processor 1034. Such data includes further data, such as a process retention time.

Table 2 shows that, in a period, the frequency that (worker A and worker B included in) group 1 has taken route P2 that is a moving sequence “1→2→3→4→6→5→7→8→9” is 550, the frequency that group 1 has taken route P1 that is a moving sequence “1→2→3→4→5→6→7→8→9” is 400, and the frequency that group 1 has taken route P3 that is a moving sequence “1→2→3→9” is 110.

### [Example of Display Screen Layout for Plurality of Groups]

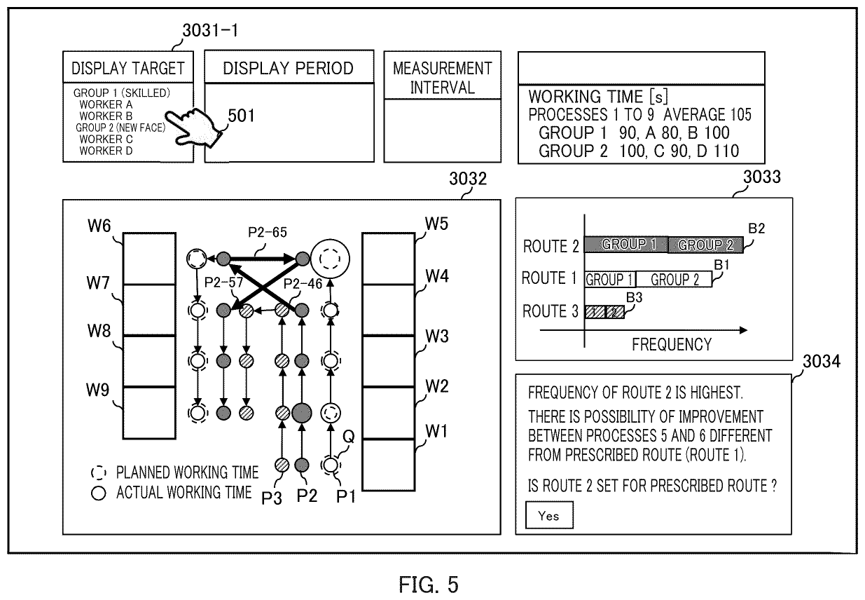

FIG. 5 is a diagram showing further another example of a display screen layout of display 104 according to the embodiment of the present disclosure. In this example, a display screen layout for a plurality of groups each including a plurality of workers is shown.

Basically, the display screen layout for one group, shown in FIG. 4, and the display screen layout for one group, shown in FIG. 5, are similar to each other and differ from each other in that, in the display screen layout for one group, shown in FIG. 4, the subject of data displayed in route display section 3032, analysis result display section 3033, and improvement suggestion display section 3034 is a plurality of groups (for example, in FIG. 5, skilled group 1 and new face group 2) selected in display target display section 3031-1. Here, as shown in FIG. 5, group 1 includes worker A and worker B, and group 2 includes worker C and worker D.

The user operates to select groups 1 and 2 from display target display section 3031-1 with pointer 501. Then, a signal according to the operation is output to mode selector 1031 via UI 105. Mode selector 1031 makes a request of activity characteristic estimator 102 for activity characteristic data on worker A and worker B included in group 1 and worker C and worker D included in group 2 in response to the operation. Activity characteristic estimator 102 outputs activity characteristic data on workers A to D to processor 103 in response to the request. Route processor 1032, analysis result processor 1033, and improvement suggestion processor 1034 execute respective processes, that is, re-generating recommended moving route data and other processes, in accordance with the activity characteristic data output from activity characteristic estimator 102, and route display section 3032, analysis result display section 3033, and improvement suggestion display section 3034 display data in respective formats.

When the user selects groups 1 and 2 in display target display section 3031-1, route display section 3032 switches routes P1 to P3 displayed as shown in FIG. 3, and displays, for example, top three routes having higher frequencies of routes along which workers A to D included in groups 1 and 2 have moved.

Analysis result display section 3033 switches frequency bars B displayed and displays the frequencies of routes P along which (workers A and B included in) group 1 and (worker C and worker D included in) group 2 have moved. At this time, frequency bars B1 to B3 may be displayed as stacked bar charts that show group 1 and group 2 as distinguished from each other.

Furthermore, improvement suggestion display section 3034 switches the displayed natural language indicating the features of activity and displays detection information on groups 1 and 2 detected in accordance with routes P and planned route Q of route display section 3032, frequency bars B of analysis result display section 3033, and the like.

Thus, the user is able to check the activity characteristics of the plurality of groups as process retention times, process moving sequences, the frequencies of the routes, and the like and intuitively find notable routes and a difference between routes and the like.

### (Examples of Operations and Examples of Display)

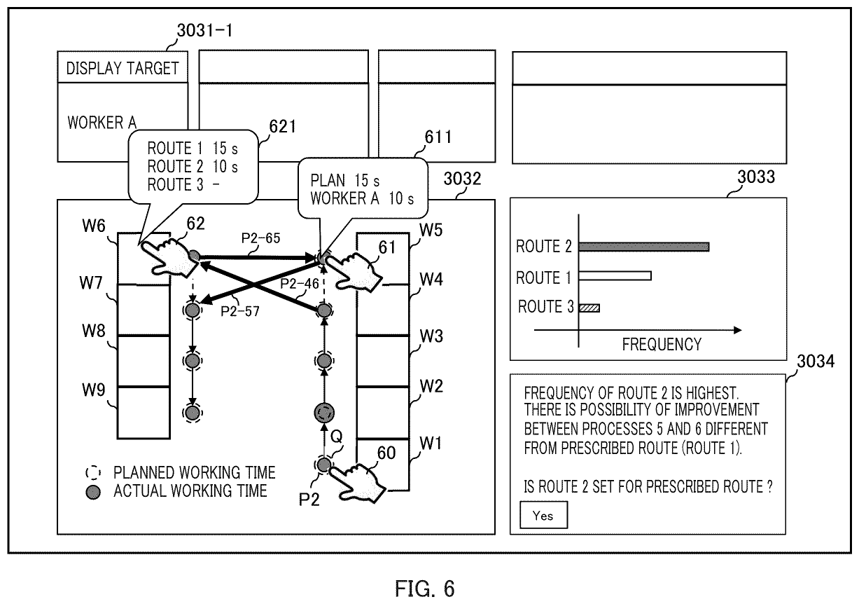

Next, examples of operations and examples of display according to user operation on display 104 will be described with reference to FIGS. 6 to 13.

### [Route Display Operation for One Worker]

FIG. 6 is a diagram showing an example of operations and display according to user operation in route display section 3032 when one worker is selected in display target display section 3031-1.

When the user performs predetermined operation in route display section 3032, route display section 3032 and improvement suggestion display section 3034 change display in accordance with the operation.

Thus, the user is able to intuitively perform, for example, comparison between planned route Q and each of plurality of routes P along which a display target worker has moved, detection of a notable point, and the like.

For example, the user performs operation to depress route P2 among routes P1 to P3 along which worker A has passed, with pointer 60 in route display section 3032. Then, a signal according to the operation is output to route processor 1032 via UI 105. Accordingly, route processor 1032 instructs route display section 3032 to delete routes P1 and P3 and display only route P2 over planned route Q.

Thus, the user is able to determine a magnitude relation between the retention times of route P2 and the planned working times of planned route Q in accordance with a difference in the sizes of circles. The user is also able to determine a difference between the moving sequence of route P2 and the planned working sequence of planned route Q in accordance with the positions and orientations of arrows.

Route processor 1032 also outputs a signal indicating that the operation has been performed, to improvement suggestion processor 1034. Accordingly, improvement suggestion processor 1034 instructs improvement suggestion display section 3034 to display detection information detected as a result of comparison between route P2 having the highest frequency and planned route Q in natural language. For example, improvement suggestion display section 3034 displays in Japanese that the route having the highest frequency is route P2, the moving sequence of route P2 differs from planned route Q in moving paths P2-46, P2-65, P2-57 and there is a possibility that processes W5, W6 near there can be improved, and the like.

Thus, the user is able to check the features of the moving route of worker A, a difference from the planned route, and the like by text and lead to improvement in work.

For example, the user performs operation to place pointer 61 on the circle corresponding to process W5 in route display section 3032. Then, a signal according to the operation is output to route processor 1032 via UI 105. Accordingly, route processor 1032 instructs route display section 3032 to display the retention time in process W5 of route P2 and the planned working time in process W5 of planned route Q with pop-up 611.

Thus, the user is able to determine a difference between the process retention time of route P2 and the planned working time of planned route Q at a glance.

For example, the user performs operation to place pointer 62 on process W6 in route display section 3032. Then, a signal according to the operation is output to route processor 1032 via UI 105. Accordingly, route processor 1032 instructs route display section 3032 to display the process retention times of routes P1 to P3 in process W6 with pop-up 621.

Thus, the user is able to determine a difference in working time among routes P1 to P3 in process W6 at a glance.

With reference to FIG. 6, through the above-described operation, the user is able to change the mode of display data in accordance with moving route data displayed on the process arrangement map and determine a difference between the process retention times and moving sequence of route P along which worker A has moved and the planned working times and planned working sequence of planned route Q at a glance.

### [Analysis Result Display Operation for One Worker]

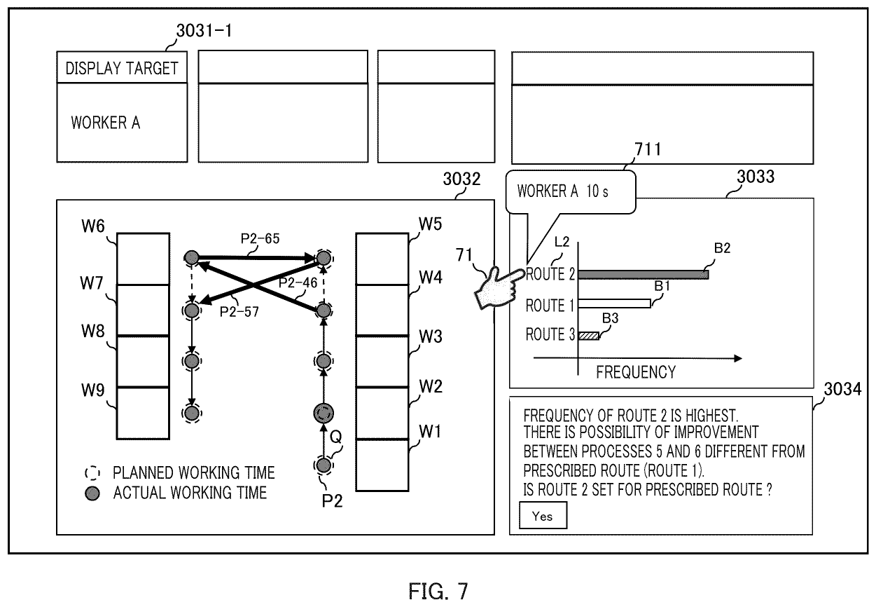

FIG. 7 is a diagram showing an example of operations and display according to user operation in analysis result display section 3033 when one worker is selected in display target display section 3031-1.

When the user performs predetermined operation in analysis result display section 3033, route display section 3032 and analysis result display section 3033 change display in accordance with the operation.

Thus, the user is able to intuitively perform, for example, comparison between planned route Q and each of plurality of routes P along which a display target worker has moved, detection of a notable point, and the like.

For example, the user performs operation to depress label L2 of frequency bar B2 among frequency bars B1 to B3 for worker A with pointer 71 in analysis result display section 3033. Then, a signal according to the operation is output to analysis result processor 1033 via UI 105. Accordingly, analysis result processor 1033 outputs a signal indicating that the operation has been performed, to route processor 1032. Accordingly, route processor 1032 instructs route display section 3032 to display only route P2 corresponding to frequency bar B2 over planned route Q.

Thus, the user is able to determine a magnitude relation between the retention times of route P2 and the planned working times of planned route Q in accordance with a difference in the sizes of circles. The user is also able to determine a difference between the moving sequence of route P2 and the planned working sequence of planned route Q in accordance with the positions and orientations of arrows.

For example, the user performs operation to place pointer 71 on label L2 of frequency bar B2 in analysis result display section 3033. Then, a signal according to the operation is output to analysis result processor 1033 via UI 105. Accordingly, analysis result processor 1033 calculates the average, maximum, or the like of all the process retention times in route P2 corresponding to frequency bar B2 and instructs analysis result display section 3033 to display the average, maximum, or the like with pop-up 711.

Thus, the user is able to easily determine the average or maximum process retention time or the like for each of routes P1 to P3.

### [Prescribed Route Setting Operation]

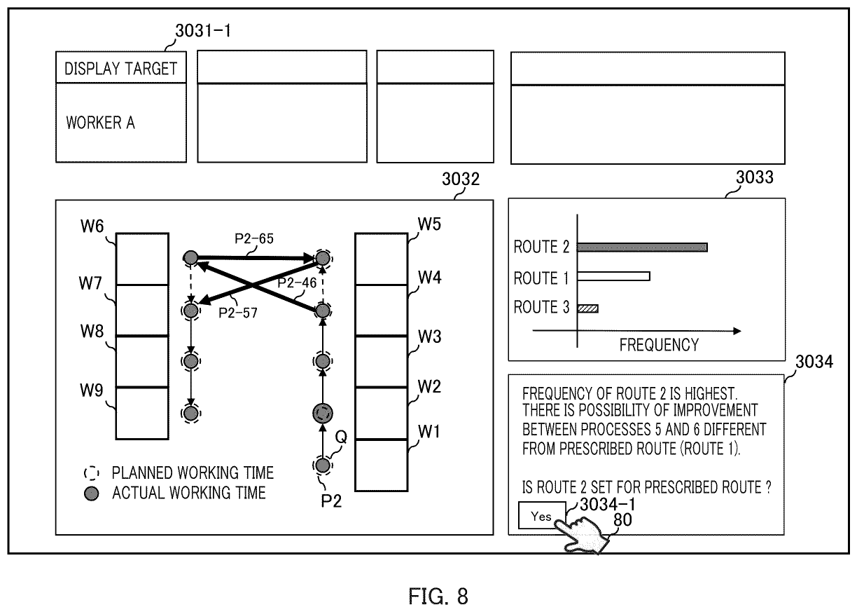

FIG. 8 is a diagram showing an example of operations and display according to user operation in improvement suggestion display section 3034 when one worker is selected in display target display section 3031-1.

Here, improvement suggestion display section 3034 displays button 3034-1 for setting specific route P (for example, route P2) as a prescribed route.

In a case where the user sets route P2 as a prescribed route, when the user depresses button 3034-1 with pointer 80, a signal according to the operation is output to improvement suggestion processor 1034 via UI 105. Accordingly, improvement suggestion processor 1034 determines to set route P2 as a prescribed route and instructs activity characteristic estimator 102 to set route P2 as a prescribed route.

Thus, the user is able to set route P2 as a target to be compared with another route, like planned route Q.

When activity characteristic estimator 102 receives instructions to set route P2 as a prescribed route from improvement suggestion processor 1034, activity characteristic estimator 102 sets moving route data of route P2 for a prescribed route and causes the data storer to store the moving route data of route P2. The set prescribed route may be displayed in route display section 3032 simultaneously with other routes for comparison, instead of planned route Q. A difference from other routes may be detected instead of planned route Q, and the difference converted into a natural language may be displayed in improvement suggestion display section 3034.

Specific route P (route P2 in this example) may be a route having the highest frequency among routes P1 to P3 or may be a route selected by the user in route display section 3032 or analysis result display section 3033.

With reference to FIG. 8, through the above-described operation, the user is able to compare selected moving route data set in accordance with an actual activity of the worker with another route, like planned route Q.

### [Process Arrangement Changing Operation]

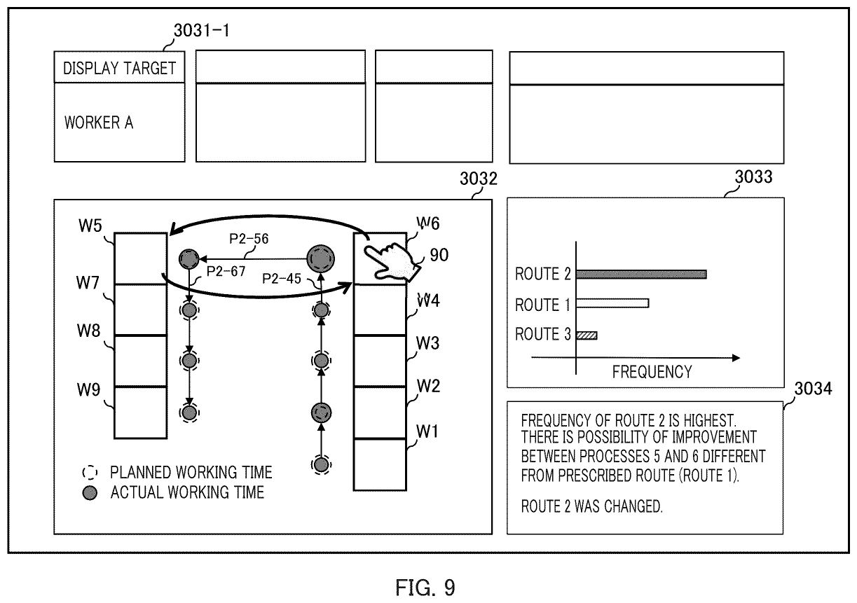

FIG. 9 is a diagram showing an example of operations and display according to user operation in route display section 3032 when one worker is selected in display target display section 3031-1.

For example, the user performs operation to move processes W of route display section 3032 in accordance with the contents displayed in improvement suggestion display section 3034. Then, route display section 3032 changes arrangement of processes W and display of route P according to the operation.

Thus, the user is able to change process arrangement and perform a simulation of activity of the worker in accordance with the contents displayed in improvement suggestion display section 3034.

For example, the user performs operation to move process W5 to the position of process W6 with pointer 90. Then, a signal according to the operation is output to route processor 1032 via UI 105. Accordingly, route processor 1032 instructs route display section 3032 to switch the positions of process W5 and process W6 and display process W5 and process W6.

Route processor 1032 outputs the changed process arrangement data to activity characteristic estimator 102 according to the operation. Activity characteristic estimator 102 re-estimates activity characteristics by using the changed process arrangement data, causes the data storer to store the activity characteristic data that is the re-estimated result, and further outputs the activity characteristic data to route processor 1032.

Accordingly, route processor 1032 re-creates recommended moving route data (third moving route) in accordance with the input activity characteristic data and instructs route display section 3032 to re-display a route that is the re-generated recommended moving route data in route display section 3032. Thus, the process moving sequence (the orientations of arrows) or the process retention times (the sizes of circles) are updated.

For example, when the positions of process W5 and process W6 are switched in FIG. 9, activity characteristic estimator 102 outputs the changed process arrangement data (the right-hand line is arranged in order of W1, W2, W3, W4, and W6 from the bottom and the left-hand line is arranged in order of W5, W7, W8, and W9 from the top), the process moving sequence of route 2 (W1→W2→W3→W4→W6→W5→W7→W8→W9), and the process retention times of route 2 (for example, process W5: 10 seconds, process W6: 30 seconds) to route processor 1032. Route processor 1032 instructs route display section 3032 to display the process moving sequence and process retention times of route 2 in accordance with the changed process arrangement data.

At this time, when activity characteristic data is stored as a transition probability between processes (FIG. 18B), a distance between processes and the sequence of arrangement change as a result of changing process arrangement, so weights may be assigned to a transition probability between processes in accordance with the proximity and whether the same transition as the planned working sequence is performed. Thus, an accumulated probability of re-estimated route 2 changes, so re-created recommended moving route data (third moving route data) is also changed.

With reference to FIG. 9, through the above-described operation, the user is able to change process arrangement and perform a simulation of activity of the worker in accordance with the contents displayed in improvement suggestion display section 3034.

With reference to FIGS. 6 to 9, through the operation as described above, the user is able to visualize the features of moving route data in a selected mode as a route by, for example, sorting in accordance with the sizes of circles, the widths and orientations of arrows, frequencies and intuitively perform comparison among a plurality of routes, detection of a notable point, and the like, which may lead to improvement in work.

### [Route Display Operation for One Group]

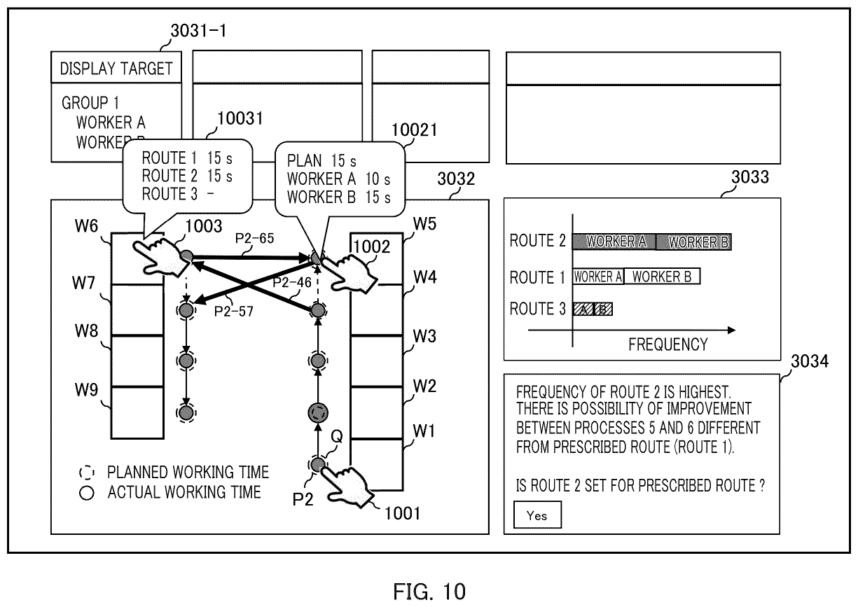

FIG. 10 is a diagram showing an example of operations and display according to user operation in route display section 3032 when one group is selected in display target display section 3031-1.

When the user performs predetermined operation in route display section 3032, route display section 3032 and improvement suggestion display section 3034 change display in accordance with the operation.

Thus, the user is able to intuitively perform, for example, comparison between planned route Q and each of routes P along which all the workers included in a display target group have moved, detection of a notable point, and the like.

For example, the user performs operation to depress route P2 among routes P1 to P3 along which the workers included in group 1 have passed, with pointer 1001 in route display section 3032. Then, a signal according to the operation is output to route processor 1032 via UI 105. Accordingly, route processor 1032 instructs route display section 3032 to delete routes P1 and P3 and display only route P2 over planned route Q.

Thus, the user is able to determine a magnitude relation between the retention times of route P2 and the planned working times of planned route Q in accordance with a difference in the sizes of circles. The user is also able to determine a difference between the moving sequence of route P2 and the planned working sequence of planned route Q in accordance with the positions and orientations of arrows.

Route processor 1032 also outputs a signal indicating that the operation has been performed, to improvement suggestion processor 1034. Accordingly, improvement suggestion processor 1034 instructs improvement suggestion display section 3034 to display detection information detected as a result of comparison between route P2 having the highest frequency and planned route Q in natural language. For example, improvement suggestion display section 3034 displays in Japanese that the route having the highest frequency is route P2, the moving sequence of route P2 differs from planned route Q in moving paths P2-46, P2-65, P2-57 and there is a possibility that processes W5, W6 near there can be improved, and the like.

Thus, the user is able to check the features of the moving route of the workers included in group 1, a difference from the planned route, and the like by text and lead to improvement in work.

For example, the user performs operation to place pointer 1002 on the circle corresponding to process W5 in route display section 3032. Then, a signal according to the operation is output to route processor 1032 via UI 105. Accordingly, route processor 1032 instructs route display section 3032 to display the retention time in process W5 of route P2 and the planned working time in process W5 of planned route Q with pop-up 10021 worker by worker.

Thus, the user is able to determine a difference between the process retention time of route P2 and the planned working time of planned route Q worker by worker at a glance.

For example, the user performs operation to place pointer 1003 on process W6 in route display section 3032. Then, a signal according to the operation is output to route processor 1032 via UI 105. Accordingly, route processor 1032 instructs route display section 3032 to display the process retention times of routes P1 to P3 in process W6 with pop-up 10031.

Thus, the user is able to determine a difference in working time among routes P1 to P3 in process W6 at a glance. The process retention time of each route may be the average, maximum, or the like for all the workers included in group 1.

With reference to FIG. 10, through the above-described operation, the user is able to change the mode of display data in accordance with moving route data displayed on the process arrangement map and determine a difference between the process retention times and moving sequence of route P along which the plurality of workers included in group 1 has moved and the planned working times and planned working sequence of planned route Q at a glance.

### [Analysis Result Display Operation for One Group]

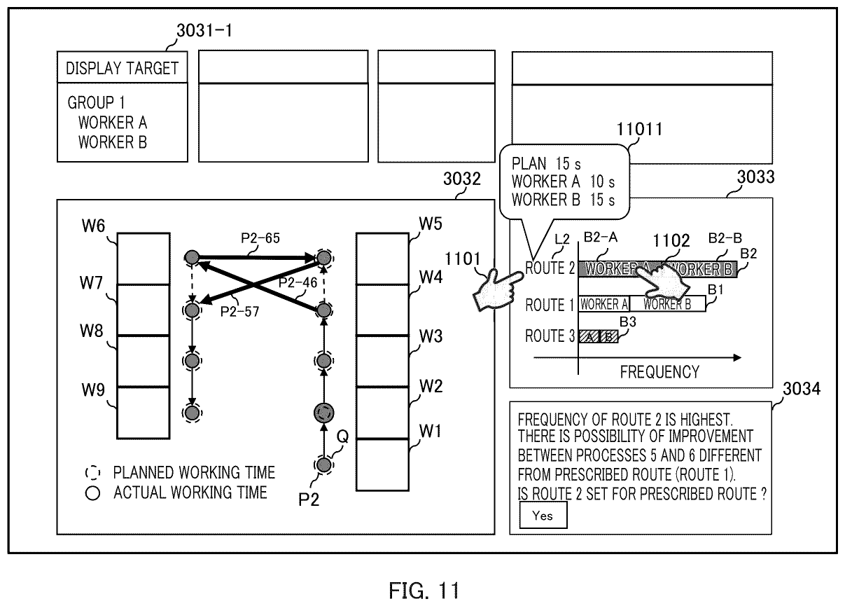

FIG. 11 is a diagram showing an example of operations and display according to user operation in analysis result display section 3033 when one group is selected in display target display section 3031-1.

When the user performs predetermined operation in analysis result display section 3033, route display section 3032 and analysis result display section 3033 change display in accordance with the operation.

Thus, the user is able to intuitively perform, for example, comparison between planned route Q and each of plurality of routes P along which all the plurality of workers included in a display target group has moved, detection of a notable point, and the like.

For example, the user performs operation to depress label L2 of frequency bar B2 among frequency bars B1 to B3 for group 1 with pointer 1101 in analysis result display section 3033. Then, a signal according to the operation is output to analysis result processor 1033 via UI 105. Accordingly, analysis result processor 1033 outputs a signal indicating that the operation has been performed, to route processor 1032. Accordingly, route processor 1032 instructs route display section 3032 to display only route P2 corresponding to frequency bar B2 over planned route Q.

Thus, the user is able to determine a magnitude relation between the retention times of route P2 and the planned working times of planned route Q in accordance with a difference in the sizes of circles. The user is also able to determine a difference between the moving sequence of route P2 and the planned working sequence of planned route Q in accordance with the positions and orientations of arrows.

For example, the user performs operation to place pointer 1101 on label L2 of frequency bar B2 in analysis result display section 3033. Then, a signal according to the operation is output to analysis result processor 1033 via UI 105. Accordingly, analysis result processor 1033 instructs analysis result display section 3033 to display the average, maximum, or the like of all the process retention times in route P2 corresponding to frequency bar B2 in analysis result display section 3033 with pop-up 11011 worker by worker.

Thus, the user is able to easily determine all the process retention times for each of routes P1 to P3.

For example, the user performs operation to depress label L2 of frequency bar B2-A for worker A of frequency bar B2 with pointer 1102 in analysis result display section 3033. Then, a signal according to the operation is output to analysis result processor 1033 via UI 105. Accordingly, analysis result processor 1033 outputs a signal indicating that the operation has been performed, to route processor 1032. Accordingly, route processor 1032 instructs route display section 3032 to display only route P2 for worker A, corresponding to frequency bar B2-A, over planned route Q. Similarly, when frequency bar B2-B is depressed, route display section 3032 displays only route P2 for worker B over planned route Q.

Thus, the user is able to quickly switch and easily perform comparison among a route with a higher frequency for all the workers included in group 1, route P for worker A, and route P for worker B.

With reference to FIG. 11, through the above-described operation, the user is able to change the mode of display data in accordance with moving route data sorted in order of frequency and determine a difference between the process retention times and moving sequence of route P along which the workers included in group I have moved and the planned working times and planned working sequence of planned route Q at a glance.

### [Route Display Operation for Plurality of Groups]

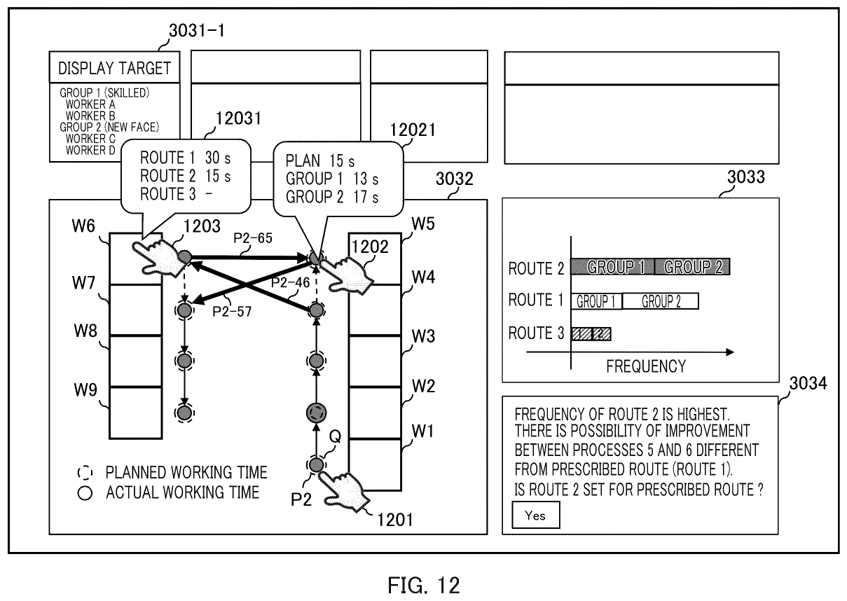

FIG. 12 is a diagram showing an example of operations and display according to user operation in route display section 3032 when a plurality of groups is selected in display target display section 3031-1.

When the user performs predetermined operation in route display section 3032, route display section 3032 and improvement suggestion display section 3034 change display in accordance with the operation.

Thus, the user is able to intuitively perform, for example, comparison between planned route Q and each of plurality of routes P along which all the workers included in a display target group have moved, detection of a notable point, and the like.

For example, the user performs operation to depress route P2 among routes P1 to P3 along which the workers included in groups 1 and 2 have passed, with pointer 1201 in route display section 3032. Then, a signal according to the operation is output to route processor 1032 via UI 105. Accordingly, route processor 1032 instructs route display section 3032 to delete routes P1 and P3 and display only route P2 over planned route Q.

Thus, the user is able to determine a magnitude relation between the retention times of route P2 and the planned working times of planned route Q in accordance with a difference in the sizes of circles. It is also possible to determine a difference between the moving sequence of route P2 and the planned working sequence of planned route Q in accordance with the positions and orientations of arrows.

Route processor 1032 also outputs a signal indicating that the operation has been performed, to improvement suggestion processor 1034. Accordingly, improvement suggestion processor 1034 instructs improvement suggestion display section 3034 to display detection information detected as a result of comparison between route P2 having the highest frequency and planned route Q in natural language. For example, improvement suggestion display section 3034 displays in Japanese that the route having the highest frequency is route P2, the moving sequence of route P2 differs from planned route Q in moving paths P2-46, P2-65, P2-57 and there is a possibility that processes W5, W6 near there can be improved, and the like.

Thus, the user is able to check the features of the moving route of the workers included in groups 1 and 2, a difference from the planned route, and the like by text and lead to improvement in work.

For example, the user performs operation to place pointer 1202 on the circle corresponding to process W5 in route display section 3032. Then, a signal according to the operation is output to route processor 1032 via UI 105. Accordingly, route processor 1032 instructs route display section 3032 to display the retention time in process W5 of route P2 and the planned working time in process W5 of planned route Q with pop-up 12021 group by group.

Thus, the user is able to determine a difference between the process retention time of route P2 and the planned working time of planned route Q group by group at a glance.

For example, the user performs operation to place pointer 1203 on process W6 in route display section 3032. Then, a signal according to the operation is output to route processor 1032 via UI 105. Accordingly, route processor 1032 instructs route display section 3032 to display the process retention times of routes P1 to P3 in process W6 with pop-up 12031.

Thus, the user is able to determine a difference in working time among routes P1 to P3 in process W6 at a glance. The process retention time of each route may be the average, maximum, or the like for all the workers included in groups 1 and 2.

With reference to FIG. 12, through the above-described operation, the user is able to change the mode of display data in accordance with moving route data displayed on the process arrangement map and determine a difference between the process retention times and moving sequence of route P along which the plurality of workers included in groups 1 and 2 has moved and the planned working times and planned working sequence of planned route Q at a glance.

### [Analysis Result Display Operation for Plurality of Groups]

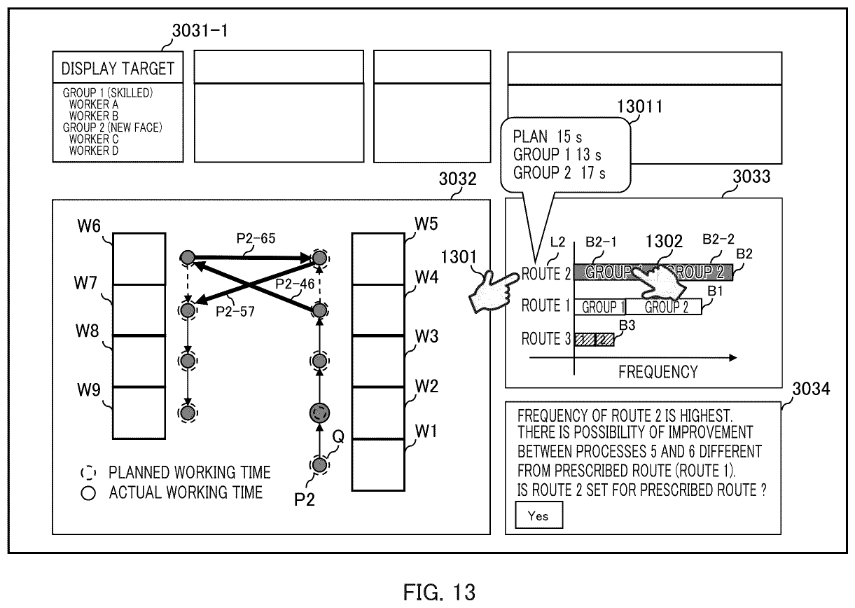

FIG. 13 is a diagram showing an example of operations and display according to user operation in analysis result display section 3033 when a plurality of groups is selected in display target display section 3031-1.

When the user performs predetermined operation in analysis result display section 3033, route display section 3032 and improvement suggestion display section 3034 change display in accordance with the operation.

Thus, the user is able to intuitively perform, for example, comparison between planned route Q and each of plurality of routes P along which all the workers included in display target groups 1 and 2 have moved, detection of a notable point, and the like.

For example, the user performs operation to depress label L2 of frequency bar B2 among frequency bars B1 to B3 for groups 1 and 2 with pointer 1301 in analysis result display section 3033. Then, a signal according to the operation is output to analysis result processor 1033 via UI 105. Accordingly, analysis result processor 1033 outputs a signal indicating that the operation has been performed, to route processor 1032. Accordingly, route processor 1032 instructs route display section 3032 to display only route P2 corresponding to frequency bar B2 over planned route Q.

Thus, the user is able to determine a magnitude relation between the retention times of route P2 and the planned working times of planned route Q in accordance with a difference in the sizes of circles. The user is also able to determine a difference between the moving sequence of route P2 and the planned working sequence of planned route Q in accordance with the positions and orientations of arrows.

For example, the user performs operation to place pointer 1301 on label L2 of frequency bar B2 in analysis result display section 3033. Then, a signal according to the operation is output to analysis result processor 1033 via UI 105. Accordingly, analysis result processor 1033 instructs analysis result display section 3033 to display the average, maximum, or the like of all the process retention times in route P2 corresponding to frequency bar B2 in analysis result display section 3033 with pop-up 13011 group by group.

Thus, the user is able to easily determine all the process retention times for each of routes P1 to P3.

For example, the user performs operation to depress frequency bar B2-1 for group 1 of frequency bar B2 with pointer 1302 in analysis result display section 3033. Then, a signal according to the operation is output to analysis result processor 1033 via UI 105. Accordingly, analysis result processor 1033 outputs a signal indicating that the operation has been performed, to route processor 1032. Route processor 1032 instructs route display section 3032 to display only route P2 for group 1 corresponding to frequency bar B2-1 over planned route Q. Similarly, when frequency bar B2-2 is depressed, route display section 3032 displays route P2 for worker B over planned route Q.

Thus, the user is able to quickly change and easily perform comparison among route P for all the workers included in groups 1 and 2, route P for group 1, and route P for worker B.

With reference to FIG. 13, through the above-described operation, the user is able to change the mode of display data in accordance with moving route data sorted in order of frequency and determine a difference between the process retention times and moving sequence of route P along which the workers included in groups 1 and 2 have moved and the planned working times and planned working sequence of planned route Q at a glance.

### (Modifications)

The present disclosure is, of course, not limited to the embodiments described above, and various modifications may be added within the range not departing from the scope.

### [Modification 1]

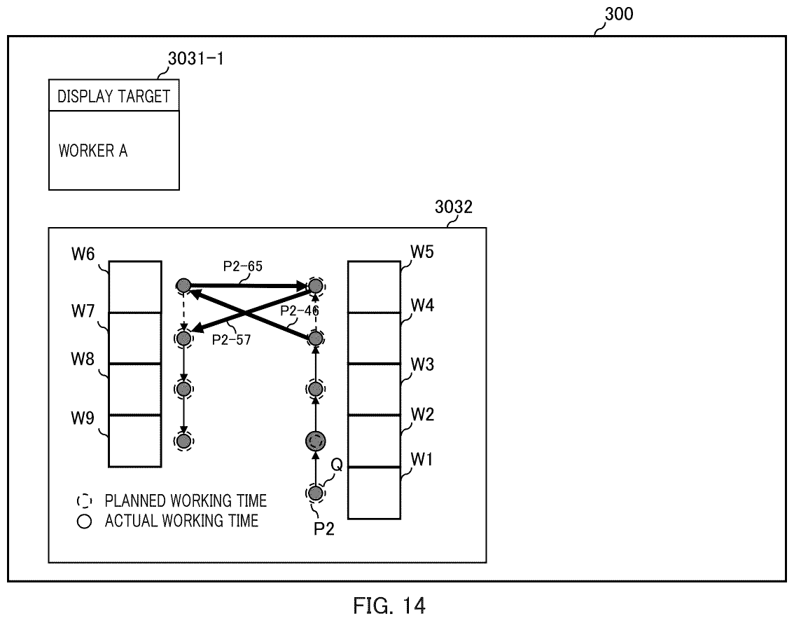

In the above description, examples of display screen layout for one worker, one group, and a plurality of groups have been described with reference to FIGS. 3 to 5; however, the present disclosure is not limited to these examples. For example, a further simple display screen may be initially displayed as a default. FIG. 14 is a diagram showing an example of a display screen layout of display 104 according to a modification of the embodiment of the present disclosure. In this example, only display target display section 3031-1 and route display section 3032 may be initially displayed in display screen 300 on display 104.

### [Modification 2]

In the above description, an example of route display operation for one worker has been described with reference to FIG. 6; however, the present disclosure is not limited to this example. For example, operations and display according to user operation in route display section 3032 may be as follows.

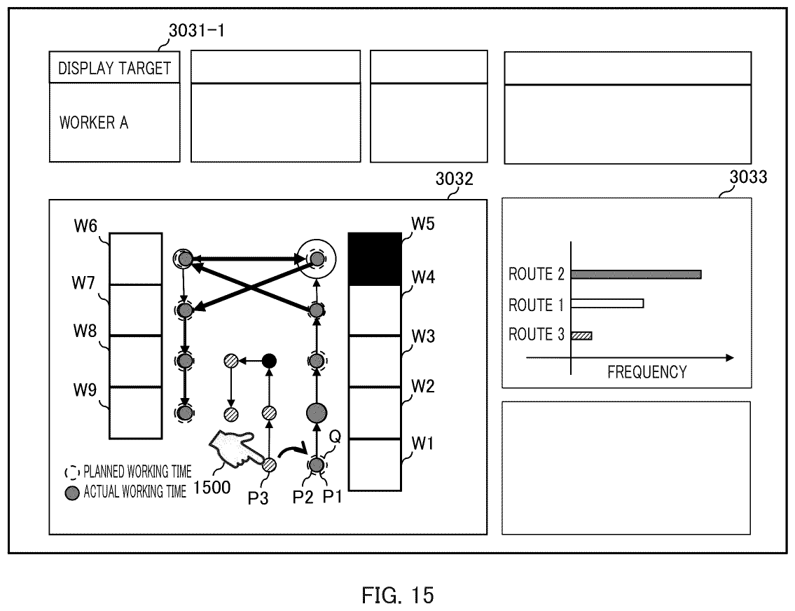

FIG. 15 is a diagram showing an example of operations and display according to user operation in route display section 3032 when one worker is selected in display target display section 3031-1.

It is assumed that, initially, as shown in FIG. 3, circles respectively representing the retention times of routes P1 to P3 along which worker A has moved are displayed so as not to overlap one another in route display section 3032.

For example, the user performs operation to move route P2 of route display section 3032 onto planned route Q with pointer 1500. Then, a signal according to the operation is output to route processor 1032 via UI 105. Accordingly, route processor 1032 instructs route display section 3032 to display the retention times of route P2 and the planned working times of planned route Q such that the centers of circles representing the retention times of route P2 overlap the centers of circles representing the planned working times of planned route Q.

Similarly, when, for example, the user performs operation to move route P3 of route display section 3032 onto planned route Q with pointer 1500, route display section 3032 displays the retention times of route P3 and the planned working times of planned route Q such that the centers of circles representing the retention times of route P3 overlap the centers of circles representing the planned working times of planned route Q.

Thus, it is possible to make it easy to perform comparison in size by displaying the process retention times of selected route P and the planned working times of planned route Q so as to overlap each other in form of concentric circles.

Conversely, when, for example, the user performs operation to move route P1 from a position on planned route Q to another position, route display section 3032 may cancel overlapping display of route P1 and planned route Q and display route P1 and planned route Q such that route P1 and planned route Q do not overlap.

### [Modification 3]

In the above description, an example of analysis result display operation for one worker has been described with reference to FIG. 7; however, the present disclosure is not limited to this example. For example, display in analysis result display section 3033 and operations and display according to user operation in analysis result display section 3033 may be as follows.

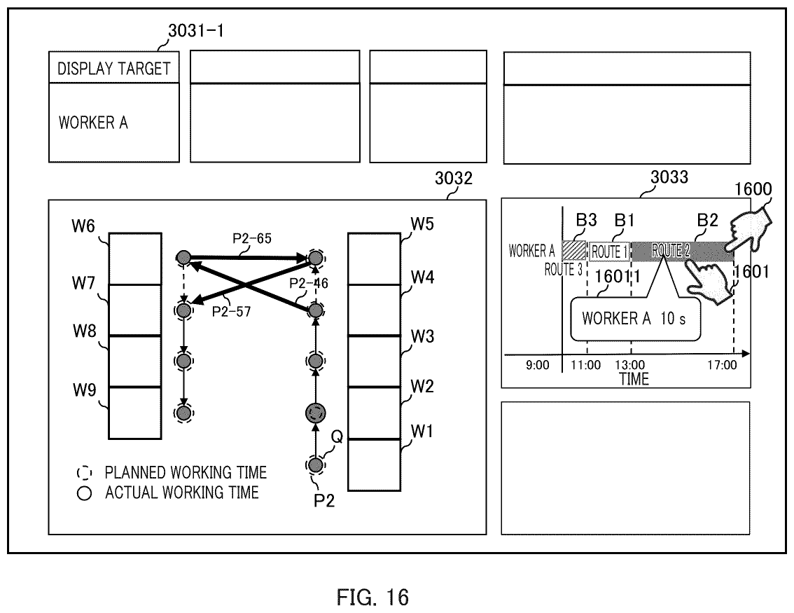

FIG. 16 is a diagram showing an example of operations and display according to user operation in analysis result display section 3033 when one worker is selected in display target display section 3031-1.

In this example, analysis result display section 3033 displays the frequencies of routes P1 to P3 with a graph in which the ordinate axis represents display target and the abscissa axis represents time, instead of display of analysis result display section 3033 shown in FIG. 3.

More specifically, in analysis result display section 3033 of FIG. 16, the ordinate axis represents display-target worker, and the abscissa axis represents time. Frequency bars B1 to B3 show routes along which worker A has moved the most at that time among routes P1 to P3 of route display section 3032. For example, in analysis result display section 3033 of FIG. 16, frequency bar B3 represents that worker A has moved along route P3 the most in a period from nine o'clock to 11 o'clock. Similarly, frequency bar B1 represents that worker A has moved along route P1 the most in a period from 11 o'clock to 13 o'clock, and frequency bar B2 represents that worker A has moved along route P2 the most in a period from 13 o'clock to 17 o'clock.

Thus, the user is able to easily check a temporal change in route along which the worker has frequently moved.

For example, the user performs operation to depress frequency bar B2 among frequency bars B1 to B3 for worker A with pointer 1600 in analysis result display section 3033. Then, a signal according to the operation is output to analysis result processor 1033 via UI 105. Accordingly, analysis result processor 1033 outputs a signal indicating that the operation has been performed, to route processor 1032. Accordingly, route processor 1032 instructs route display section 3032 to display route P2 corresponding to frequency bar B2 over planned route Q.

Thus, the user is able to determine a magnitude relation between the retention times of route P2 and the planned working times of planned route Q in accordance with a difference in the sizes of circles. The user is also able to determine a difference between the moving sequence of route P2 and the planned working sequence of planned route Q in accordance with the positions and orientations of arrows.

For example, the user performs operation to place pointer 1601 on label L2 of frequency bar B2 in analysis result display section 3033. Then, a signal according to the operation is output to analysis result processor 1033 via UI 105. Accordingly, analysis result processor 1033 instructs analysis result display section 3033 to display the average, maximum, or the like of all the process retention times in route P2 corresponding to frequency bar B2 in analysis result display section 3033 with pop-up 16011.

Thus, the user is able to easily determine the average or maximum process retention time or the like for each of routes P1 to P3.

### Advantageous Effects of Embodiment

A route generation and display apparatus (worker's activity estimation system 100) according to the embodiment of the present disclosure includes an extractor (activity characteristic estimator 102) generating a first moving route taken by each of one or a plurality of workers from time-series data of positional information indicating that the one or plurality of workers has worked in a plurality of processes and extracting an activity characteristic associated with times and processes of the first moving route, a processor (processor 103, route processor 1032) generating a second moving route recommended for the worker in accordance with the first moving route and the activity characteristic, and a display (display 104, route display section 3032) displaying the second moving route. In this way, the second moving route recommended for a worker is displayed to a user. Thus, the user is able to check a moving route recommended for a worker to judge whether worker's activity is appropriate.

In the route generation and display apparatus, the extractor (activity characteristic estimator 102) calculates a frequency of the first moving route as the activity characteristic, and the processor (processor 103, route processor 1032) generates a second moving route in accordance with the frequency of the first moving route. Thus, the user is able to judge whether worker's activity is appropriate, such as whether the second moving route having the highest frequency should be set as a new prescribed route, and identify portions to be improved in the production line as a whole.

In the route generation and display apparatus, the display (display 104, route display section 3032) displays the second moving route and a prescribed route that is a working reference of the worker. Thus, the user is able to easily check and detect a difference between an actual activity of a worker and a plan by performing comparison between the second moving route and the prescribed route that is a working reference. Therefore, it is possible to judge whether worker's activity is appropriate and identify portions to be improved in the production line as a whole.

In the route generation and display apparatus, in response to input indicating that one moving route of the second moving route is selected, the display (display 104, route display section 3032) displays the one moving route over the prescribed route. Thus, the user is able to further easily check and detect a difference between an actual activity of a worker and a plan by performing comparison between the selected moving route and the prescribed route that is a working reference. Therefore, it is possible to judge whether worker's activity is appropriate and identify portions to be improved in the production line as a whole.

In the route generation and display apparatus, the processor (processor 103, improvement suggestion processor 1034) converts information that there is room for improvement in the prescribed route into a natural language in accordance with a difference between the prescribed route and a moving route having the highest frequency, of the second moving route, and the display (display 104, improvement suggestion display section 3034) displays the natural language. Thus, the user is able to further easily identify portions to be improved in the production line as a whole by reading the displayed natural language.

In the route generation and display apparatus, in response to input indicating that the moving route having the highest frequency of the second moving route is set to a new prescribed route, the processor (processor 103, improvement suggestion processor 1034) sets the moving route having the highest frequency of the second moving route, as the new prescribed route in place of the prescribed route. Thus, the user is able to hereafter allow the worker to work in an easy-to-work route and improve productivity in the production line.

In the route generation and display apparatus, the display (display 104, route display section 3032) displays the second moving route and process arrangement, in response to input indicating that the process arrangement is changed, processor (processor 103, route processor 1032) generates a third moving route in which a process moving sequence included in the second moving route is changed, in accordance with the activity characteristic, and the display (display 104, route display section 3032) displays the third moving route. Thus, the user is able to perform a simulation of activity of the worker and lead to improvement in productivity in the production line.

In the route generation and display apparatus, the display (display 104, route display section 3032) displays a process retention time included in the second moving route with a size of a circle and displays a process moving sequence included in the second moving route with an orientation of an arrow. Thus, the user is able to intuitively keep track of a difference in process retention time and process moving sequence between the second moving routes and a difference in process retention time and process moving sequence between each of these second moving routes and the prescribed route or new prescribed route that is a working reference.

In the route generation and display apparatus, in response to input indicating that a circle is selected, the display (display 104, route display section 3032) displays the process retention time in numbers. Thus, the user is able to accurately keep track of the process retention time.

In the embodiment described above, the notation “ . . . processor”, “ . . . -er”, “ . . . -or” or “ . . . -ar” used for each component may be replaced with another notation such as “. . . circuitry”, “ . . . assembly”, “ . . . device”, “ . . . unit” or “ . . . module”.

Although the embodiment has been described above with reference to the accompanying drawings, the present disclosure is not limited to such examples. It is obvious that a person skilled in the art can arrive at various variations and modifications within the scope recited in the claims. It is understood that such variations and modifications also belong to the technical scope of the present disclosure. Further, components in the embodiment described above may be arbitrarily combined without departing from the spirit of the present disclosure.

The present disclosure can be realized by software, hardware, or software in cooperation with hardware. Each functional block used in the description of the embodiment described above can be partly or entirely realized by a large scale integration (LSI) such as an integrated circuit, and each process described in the embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a field programmable gate array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

### Summary of Embodiment

A route generation and display apparatus according to one exemplary embodiment of the present disclosure includes: an extraction circuit that generates a first moving route taken by each of one or a plurality of workers from time-series data of positional information indicating that the one or plurality of workers has worked in a plurality of processes and that extracts an activity characteristic associated with times and processes of the first moving route: a processing circuit that generates a second moving route recommended for the worker, in accordance with the first moving route and the activity characteristic; and a monitor that displays the second moving route.

In the route generation and display apparatus, the extraction circuit calculates a frequency of the first moving route as the activity characteristic, and the processing circuit generates the second moving route based on the frequency of the first moving route.

In the route generation and display apparatus, the monitor displays the second moving route and a prescribed route that is a working reference of the worker.

In the route generation and display apparatus, in response to input indicating that one moving route of the second moving route is selected, the monitor displays the one moving route over the prescribed route.

In the route generation and display apparatus, the processing circuit converts information that there is room for improvement in the prescribed route into a natural language in accordance with a difference between the prescribed route and a moving route having the highest frequency, of the second moving route, and the monitor displays the natural language.

In the route generation and display apparatus, in response to input indicating that a moving route having the highest frequency of the second moving route is set to a new prescribed route, the processing circuit sets the moving route having the highest frequency, of the second moving route, as the new prescribed route in place of the prescribed route.

In the route generation and display apparatus, the monitor displays the second moving route and process arrangement, in response to input indicating that the process arrangement is changed, the processing circuit generates a third moving route in which a process moving sequence included in the second moving route is changed, in accordance with the activity characteristic, and the monitor displays the third moving route.

In the route generation and display apparatus, the monitor displays a process retention time included in the second moving route with a size of a circle and displays a process moving sequence included in the second moving route with an orientation of an arrow.

In the route generation and display apparatus, in response to input indicating that the circle is selected, the monitor displays the process retention time in numbers.

A route generation and display method according to one exemplary embodiment of the present disclosure includes: generating a first moving route taken by each of one or a plurality of workers from time-series data of positional information indicating that the one or plurality of workers has worked in a plurality of processes; extracting an activity characteristic associated with times and processes of the first moving route; generating a second moving route recommended for the worker, in accordance with the first moving route and the activity characteristic; and displaying the second moving route.

The disclosure of Japanese Patent Application No. 2021-147098, filed Sep. 9, 2021, including the specification, drawings, and abstract, is incorporated herein by reference in its entirety.

### INDUSTRIAL APPLICABILITY

An embodiment of the present disclosure is useful in a route generation and display apparatus that generates and displays a moving route.

### REFERENCE SIGNS LIST

10 Production line
100 Worker's activity estimation system
101 Data acquirer
102 Activity characteristic estimator
103 Processor
1031 Mode selector
1032 Route processor
1033 Analysis result processor
1034 Improvement suggestion processor
104 Display
105 UI
3031 Mode display section
3031-1 Display target display section
3031-2 Display period display section
3031-3 Measurement interval display section
3031-4 Working time display section
3032 Route display section
3033 Analysis result display section
3034 Improvement suggestion display section

1. A route generation and display apparatus, comprising:
an extraction circuit that generates a first moving route taken by each of one or a plurality of workers from time-series data of positional information indicating that the one or plurality of workers has worked in a plurality of processes and that extracts an activity characteristic associated with times and processes of the first moving route;
a processing circuit that generates a second moving route recommended for the worker, in accordance with the first moving route and the activity characteristic; and
a monitor that displays the second moving route.

2. The route generation and display apparatus according to claim 1, wherein
the extraction circuit calculates a frequency or an accumulated probability of the first moving route as the activity characteristic, and
the processing circuit generates the second moving route based on the frequency or the accumulated probability of the first moving route.

3. The route generation and display apparatus according to claim 2, wherein
the monitor displays the second moving route and a prescribed route that is a working reference of the worker.

4. The route generation and display apparatus according to claim 3, wherein
in response to input indicating that one moving route of the second moving route is selected, the monitor displays the one moving route over the prescribed route.

5. The route generation and display apparatus according to claim 3, wherein
the processing circuit converts information that there is room for improvement in the prescribed route into a natural language in accordance with a difference between the prescribed route and a moving route having the highest frequency or the highest accumulated probability, of the second moving route, and
the monitor displays the natural language.

6. The route generation and display apparatus according to claim 5, wherein
in response to input indicating that the moving route having the highest frequency or the highest accumulated probability of the second moving route is set to a new prescribed route, the processing circuit sets the moving route having the highest frequency or the highest accumulated probability, of the second moving route, as the new prescribed route in place of the prescribed route.

7. The route generation and display apparatus according to claim 1, wherein
the monitor displays the second moving route and process arrangement,
in response to input indicating that the process arrangement is changed, the processing circuit generates a third moving route in which a process moving sequence included in the second moving route is changed, in accordance with the activity characteristic, and
the monitor displays the third moving route.

8. The route generation and display apparatus according to claim 1, wherein
the monitor displays a process retention time included in the second moving route with a size of a circle and displays a process moving sequence included in the second moving route with an orientation of an arrow.

9. The route generation and display apparatus according to claim 8, wherein
in response to input indicating that the circle is selected, the monitor displays the process retention time in numbers.

10. A route generation and display method, comprising:
generating a first moving route taken by each of one or a plurality of workers from time-series data of positional information indicating that the one or plurality of workers has worked in a plurality of processes;
extracting an activity characteristic associated with times and processes of the first moving route;
generating a second moving route recommended for the worker, in accordance with the first moving route and the activity characteristic; and
displaying the second moving route.
